(19) United States
(12) Patent Application Publication
(10) Pub. No.: US 2012/0274063 A1
(43) Pub. Date: Nov. 1, 2012

(54) PIPE CONNECTING APPARATUS

(76) Inventor: Harold Kennedy, JR., Fuquay Varina, NC (US)

(21) Appl. No.: 13/454,619

(22) Filed: Apr. 24, 2012

Related U.S. Application Data
(60) Provisional application No. 61/480,403, filed on Apr. 29, 2011.

(51) Int. Cl. F16L 23/00

(52) U.S. Cl. 285/364

(57) ABSTRACT

A pipe connecting apparatus includes an outer gland assembly having a plurality of outer gland segments adapted to engage first and second pipes, a sealing member, and an inner gland assembly. Each outer gland segment has an arcuate wall with a groove formed therein, a rear wall extending radially inward from the arcuate wall, and a pair of connection members. The outer gland segments, when connected, define an annular groove and an adjacent annular space. The annular groove receives an outer edge of a bell end flange. The sealing member is disposed within the annular space and the inner gland assembly is disposed within the annular space adjacent the sealing member. The inner gland assembly includes a plurality of pipe gripping members, each pivotable within the annular space in response to an axial force such that a respective tooth of each is inserted into a surface of the first pipe.

### RELATED APPLICATION

This application claims the benefit of and priority to U.S. Provisional Patent Application No. 61/480,403 filed Apr. 29, 2011, the disclosure of which is incorporated herein by reference as if set forth in its entirety.

### FIELD OF THE INVENTION

This invention relates generally to pipe coupling and, more particularly, to devices used to join pipes together.

### BACKGROUND

A majority of pipe and fitting joints fall into roughly three groups: A) Push-on joints, B) Mechanical joints, and C) Flange Joints.

Push-on joints consist of a rubber ring contained within the enlarged end of a pipe (bell). A seal is obtained by pushing the beveled end of a pipe through the rubber ring, deflecting the rubber ring and creating an o-ring type seal. The deflection of the gasket and hence the seal is greatly dependent upon tight tolerances on the inside diameter of the bell and the outside diameter of the end of the inserted pipe. The tendency of the pipe end to shift downward and rest on the inside of the bell is called “off-set” and adds to the gap or space for the gasket to seal. The external forces, i.e. weight of the inserted pipe and earth load, that tend to off-set the pipe end also cause the pipe to deflect into an oval shape. This deflection also adds to the space to be filled by the gasket so that the maximum space caused by the off-set and deflection of the pipe end can be as much as four (4) times the tolerance spread between pipe outside diameter and the bell inside diameter. Lubrication may be required during coupling of pipes via a push-on joint.

Mechanical joints are usually compression type seals. That is, a gasket (usually wedge shaped) is inserted into the end of the bell completely filling the space between the pipe and bell. A ring (gland) pushes on the gasket to apply enough force to compress the gasket against the bell and pipe surface (gasket seat) and obtain a seal. The force is applied by the tightening of several bolts located around the gland and bell in the axial direction. For example the number of bolts range from four (4) on a 4″ pipe joint to twenty four (24) on a 36″ pipe joint. The gasket seat is fixed and is defined by the internal shape of the mechanical joint bell. The seal relies on the torque of the bolts. Lubrication is recommended during coupling of pipes via a mechanical joint.

Flange joints are also compression type joints and involve the use of a flat gasket on a flat radial surface. The compression is also supplied by tightening several bolts usually to a high torque level. Lubrication is not required and is not recommended during coupling of pipes via a flange joint.

A flange is an integral part of a pipe or fitting and is therefore restrained. That is, hydraulic thrust is resisted by the flange through the bolts used to compress the gasket.

Mechanical joint glands are not an integral part of a pipe and therefore hydraulic thrust will separate the joint. Restraint is provided by special restraining glands, such as described in U.S. Pat. No. 5,071,175 to Kennedy. Note that additional bolts need to be tightened to force toothed wedges against the pipe surface. There can be as many wedge bolts as the gland bolts. For example, a 12″ pipe has eight (8) gland bolts and eight (8) wedge bolts, which greatly increases the time required to properly assemble the restrained mechanical joint.

Many types of pipe are used throughout the world, each having a set of outside diameters specific to a national specification. In the U.S. the most often used diameters for water pipe are Ductile Iron Pipe Size (DIPS) and Iron Pipe Size (IPS). IPS refers to the outside diameters used by steel pipe. Plastic pipe is furnished to both diameter standards. DIPS diameters are larger than IPS outside diameters.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

Pipe connecting apparatus, according to embodiments of the present invention have numerous advantages over conventional pipe connecting apparatus including the ability to seal and restrain against hydraulic thrust. Pipe connecting apparatus according to embodiments of the present invention allow increased tolerances of the pipe end and bell diameters, and are not affected by off-set. In addition, pipe connecting apparatus according to embodiments of the present invention require no beveling of pipe ends, and can be cast with only one core. Furthermore, pipe connecting apparatus according to embodiments of the present invention do not require lubricant during pipe coupling, can accommodate both DIPS and IPS pipe sizes, and use fewer bolts than mechanical joints to both seal and restrain (usually two in the 4″-12″ sizes.)

Pipe connecting apparatus according to embodiments of the present invention may be used with plastic pipe, thin walled metal pipes and in some embodiments may be used on ductile iron or steel pipe. Pipe connecting apparatus according to embodiments of the present invention solve the problems of tight tolerances, off-set and deflection, and the large number of bolts required by conventional pipe connecting apparatus. The parts may be cast of metal or molded of plastic or fabricated of steel, for example. In the case of casting, the improvements provide for a reduced number of cores.

According to some embodiments of the present invention, a bell consists of an expanded annular space on the pipe or fitting adapted to receive an adjoining pipe end inserted into the expanded space. The bell is surrounded by a flange-like rim having a sealing surface located on the end (bell face). The bell does not enclose a gasket or sealing ring. In some embodiments, the flange-like rim includes at least two keyway-like notches.

Separate from the bell is a compound gland, consisting of at least two segments having side extensions adapted to receive bolts or other closing devices. The at least two compound gland segments enclose the flange-like rim and are closed by bolts held by two side extensions. The compound gland contains a resilient sealing ring adapted to be compressed when the bolts are tightened. The sealing ring seals against the bell face and the surface of the inserted pipe. The compound gland also contains multiple thrust restraining cam-like toothed wedges that are partially inserted into the pipe surface by the tightening of the bolts. Reference will be made to the action of these two segments or gland halves but it will be understood that multiple segments connected to each other may also be used. The sealing ring is adapted to contact the bell face and pipe surface before contact is made by the restraining wedges.

The compound gland consists of an outer gland assembly to which the bolts are attached and an inner gland assembly adapted to contain a rubber sealing ring or gasket and multiple restraining cam-like wedges having tooth-like ridges adapted to be inserted into the pipe surface.

In some embodiments, the inner gland consists of a gasket seat for the sealing ring adapted to seal against the radial sealing surface of the flange-like rim on the bell. The inner gland assembly also contains multiple supports to hold multiple cam-like wedges (also referred to herein as pipe gripping members). An inner gland assembly according to other embodiments of the present invention may contain the supports only, with the gasket seat being an integral part of the outer gland. The cam-like wedges rotate as axial force is applied, cutting deeper grooves in the adjoining pipe surface. The outer gland assembly resists radial and axial thrust and in combination with the inner gland supports and acts as a stop to control the position of the cam-like wedges during tightening of the bolts and during subsequent rotation of the cams. The inner gland may be cast without the use of cores.

The cam-like wedges comprise almost the complete circumference of the pipe leaving only the small separation required to allow free rotation without interference by adjoining wedge teeth. While it is known to locate rotating toothed restraints in a split coupling, as described for example in U.S. Pat. No. 2,473,046 to Adams, the teeth may contact the pipe surface with considerable stress in order to get an initial partial insertion to subsequently respond to axial force and cause rotation. Conventionally, this is accomplished by limiting the number and location of the restraints so that the force direction of the bolting acts to insert the teeth of the segments into the surface of the pipe, as described in U.S. Pat. No. 1,930,194 to Dillon. With only two semicircular clamping halves this is limited to locations near the center of each coupling half.

There are also many pipe restraining clamps comprising two halves with integral continuous circumferential teeth either cast or machined into the solid clamp half. These circumferential teeth are designed to bite into the pipe surface as the side bolts are tightened. See, for example, U.S. Pat. No. 3,252,192 to Smith, U.S. Pat. No. 4,568,112 to Bradley and U.S. Pat. No. 5,190,324 to Bird. These conventional clamps have an inside radius slightly less than the diameter of the pipe, resulting in the creation of scratches or grooves near the side bolts as the teeth move in a circumferential direction. The teeth 90° from the side bolts, however, move toward the pipe surface and not along the circumference. The result is good grooves near the bolts and few or no groves 90° away.

According to some embodiments of the present invention, the inside radius of the outer and inner gland assemblies as well as the radius of the toothed segments, is considerably larger than the radius of the pipe surface. As the bolts are tightened, the pipe surface is contacted at two diametrically opposed points causing the pipe to deflect into an oval or ellipsoidal shape. Initial contact is made at the center between the side bolts 90° away from the ends of the gland halves. As pipe deflection continues the surface of the pipe is brought into contact with the gasket first and then the teeth of the cam-like wedges. In this way as the compound gland is closed, the circumference of the inserted pipe completely fills the reduced inside circumference of the gland and subsequent tightening of the side bolts compresses the sealing ring and partially inserts all of the wedge teeth into the surface of a PVC or HDPE pipe. The cam-like wedges may be cast without the use of cores and there is no requirement for machining.

To facilitate this deflection, the outer gland assembly is composed of two annular spaces. The first annular space is a groove and fits over and is guided by the flange-like rim of the fitting bell while the second annular space consists of a circumferential surface and a rear wall. The second annular space contains the inner gland assembly, cam-like wedges, and gasket. The first annular space is a true 180° semicircle. While the second is a partial semicircle encompassing less than 180° with the center offset by a predetermined amount from the center of the first groove. Thus the radial wall and the inner gland assembly, contained in the second annular space, act to drive the pipe surface into an oval shape to seal the gasket and insert the cam teeth. The pipe surface (diameter) is deflected in an axial first plane and expands in a second axial plane so that the wedges are pushed into the pipe in the first plane and the surface of the pipe is pushed onto the teeth by the expansion in the second plane nearest the bolts. Utilizing a spacer in each bolt area to limit the closing and contain the gasket, both DIPS (with the spacer) and IPS (with the spacer removed) can be accommodated. In this manner both DIPS and IPS plastic pipe sizes can be sealed and restrained without the necessity to change to a transition gasket as in a conventional mechanical joint or to remove an extra gasket as described in U.S. Pat. No. 6,293,556 to Krausz. The outer gland assembly may be cast without the use of cores.

During insertion of the pipe end through the compound gland and sealing ring into the bell, the gland halves are kept open and centered. This is accomplished by two centering and separating spacers located between the side extensions. In some embodiments the spacers are made of plastic, rubber, or metal. The flange-like rim contains multiple diametrically opposed keyway notches, adapted to receive a key-like portion of the spacer. When the bolts are tightened against the spacers the portion of the spacers within the notches firmly stabilize and center the compound gland halves. When the bolts are loosened after insertion of the pipe end, the spacers can be removed without the necessity to completely remove the bolts. As the spacers are removed, the gland halves will off-set in the downward direction. The spacer has a tapered extension beyond the key portion long enough to protrude outside the side extensions of the gland halves to assist in the removal of the spacer without the necessity to insert a finger into the space between the side extensions. The taper slows the off-setting of the gland so as to prevent the pinching of fingers, etc. The complete tightening of the bolts with the spacers removed compresses the sealing ring and partially inserts the wedge teeth into the pipe surface.

Pipe connecting apparatus according to embodiments of the present invention may be designed for either DIPS or IPS pipe dimensions or both. If the design accommodates only one (DIPS or IPS) set of pipe diameters then the centering and stabilizing spacers only are utilized. However, if a single design accommodates both DIPS and IPS then bridging spacers are utilized in addition to the centering and stabilizing spacers. The bridging spacer fills the space between the side extensions when DIPS pipe is used. The bridging spacers are removed when IPS pipe is used with the dual type design. The bridging spacer covers the gasket and prevents blow out of the sealing ring through the gap between the halves of the compound gland.

According to some embodiments of the present invention, a pipe connecting apparatus is provided for coupling pipe ends, wherein an end of a first pipe is inserted into a bell housing on an end of a second pipe, and wherein the bell housing has a radially outwardly extending flange. The apparatus includes an outer gland assembly comprising a plurality of outer gland segments adapted to engage the first and second pipes, a sealing member, and an inner gland assembly. Each outer gland segment has an arcuate wall with a groove formed therein, a rear wall extending radially inward from the arcuate wall, and a pair of connection members for adjustably connecting one outer gland segment to one or more other outer gland segments via fasteners. The outer gland segments, when connected, define an annular groove and an adjacent annular space, wherein the annular groove is configured to receive an outer edge of the bell end flange. The sealing member is disposed within the annular space and is adapted to surround the first pipe, abut against the bell end flange, and provide a seal between the first and second pipes. The inner gland assembly is disposed within the annular space adjacent the sealing member and is adapted to surround the first pipe. The inner gland assembly includes a plurality of pipe gripping members, wherein each pipe gripping member has at least one tooth. Each pipe gripping member is pivotable within the annular space in response to an axial force on the first and second pipes and such that each pipe gripping member at least one tooth is inserted into a surface of the first pipe.

In some embodiments of the present invention, the rear walls of the outer gland segments, when connected, define an inside diameter that is larger than an outside diameter of the first pipe, and define a circumference that is substantially equal to a circumference of the first pipe. In some embodiments of the present invention, the plurality of outer gland segments are two outer gland segments. The rear walls of the two outer gland segments, when connected, define an inside diameter that is larger than an outside diameter of the first pipe, and define a circumference that is substantially equal to a circumference of the first pipe.

Each pipe gripping member has an arcuate pipe engaging face with opposite front and rear edges and at least one elongated, arcuate tooth extending outwardly from the pipe engaging face between the front and rear edges. In some embodiments of the present invention, each pipe gripping member has a plurality of elongated, arcuate teeth. In some embodiments of the present invention, each pipe gripping member tooth includes front and rear walls converging to form a gripping edge, and a portion of the pipe engaging face between the front edge thereof and the tooth front wall forms an angle with the tooth front wall of less than ninety degrees (90°).

In some embodiments of the present invention, each pipe gripping member has a planar rear face opposite the pipe engaging face and a planar axial load bearing surface extending between the rear face and pipe engaging face. The axial load bearing surface defines a plane having an angle relative to a plane defined by the rear face of less than ninety degrees (90°). In some embodiments of the present invention, the axial load bearing surface defines a plane having an angle relative to a plane defined by the rear face of between about seventy five degrees and about eighty five degrees (75°-85°).

In some embodiments of the present invention, the rear face of each of the pipe gripping members includes an arcuate edge portion that facilitates pivotal movement of the pipe gripping members within the annular space. Each gripping member is pivotable within the annular space, for example, between about five degrees and about fifteen degrees) (5°-15°). However, in other embodiments of the present invention, each gripping member may be pivotable by an amount greater than fifteen degrees (15°) or may be pivotable by an amount less than five degrees (5°).

The inner gland assembly includes a plurality of inner gland segments. Each inner gland segment is secured to a respective outer gland segment, and each inner gland segment has opposite front and rear sides. The front side of each inner gland segment abuts the sealing member, and the rear side of each inner gland segment includes a plurality of circumferentially spaced-apart supports extending outwardly therefrom that are adapted to support one or more pipe gripping members. In some embodiments of the present invention, each gripping member includes opposite end portions and each end portion is configured to engage and be supported by a respective support.

In some embodiments of the present invention, each outer gland segment arcuate wall includes at least one notch formed therein. Each inner gland segment includes at least one alignment tab that is configured to be received within the at least one notch to align the inner gland segment with the outer gland segment.

The bell end flange outer edge includes a plurality of notches, and the outer gland segments are positioned such that a notch is located between respective connection members of adjacent outer gland segments. A plurality of spacers are provided for engagement with the respective plurality of notches. In some embodiments of the present invention, each spacer has an elongated key member that is configured to extend between the respective connection members and to removably engage a respective notch. In some embodiments of the present invention, the elongated key member of each spacer includes a free end portion having a tapered configuration.

In some embodiments of the present invention each connection member of an outer gland segment includes a groove. Each spacer includes a pair of opposing ribs extending outwardly from the elongated key member that are configured to slidably engage grooves in respective connection members of adjacent outer gland segments.

In some embodiments of the present invention, each spacer includes an elongated side arm oriented transverse to the elongated key member. The elongated side arm facilitates removable engagement of a respective spacer with a notch in the bell end flange.

In some embodiments of the present invention, the sealing member is attached to the outer gland assembly within the annular space of the outer gland assembly.

In some embodiments of the present invention, the inner gland segments and pipe gripping members are formed from polymeric material. In other embodiments, the inner gland segments and pipe gripping members are formed from iron, steel, or aluminum. However, other materials may be utilized.

In some embodiments of the present invention, the outer gland segments are formed from iron, steel, or aluminum. However, other materials may be utilized.

According to other embodiments of the present invention, a pipe connecting apparatus includes a bell housing having opposite first and second ends, an outer gland assembly, a sealing member, an inner gland assembly, and a plurality of spacers. The first end of the bell housing is adapted to receive a pipe end therethrough and includes a radially outwardly extending flange. An outer edge of the flange includes a plurality of circumferentially spaced-apart notches.

The outer gland assembly includes a plurality of outer gland segments. Each outer gland segment includes an arcuate wall with a groove formed therein, a rear wall extending radially inward from the arcuate wall, and a pair of connection members for adjustably connecting one outer gland segment to one or more other outer gland segments via fasteners. The outer gland segments, when connected, define an annular groove and an adjacent annular space. The annular groove receives the outer edge of the bell end flange, and the outer gland segments are positioned such that a notch in the bell end flange is located between respective connection members of adjacent outer gland segments. Each spacer has an elongated key member that is configured to extend between respective connection members of adjacent outer gland segments and to removably engage a respective notch in the bell end flange.

The sealing member is disposed within the annular space and is adapted to surround a pipe inserted within the bell housing first end and abut against the bell end flange. The inner gland assembly is disposed within the annular space adjacent the sealing member and is adapted to surround a pipe inserted within the bell housing first end. The inner gland assembly includes a plurality of pipe gripping members. Each pipe gripping member includes at least one tooth and is pivotable within the annular space in response to an axial force on the pipe such that pipe gripping member teeth are inserted into a surface of the pipe.

In some embodiments of the present invention, the rear walls of the outer gland segments, when connected, define an inside diameter that is larger than an outside diameter of the pipe, and define a circumference that is substantially equal to a circumference of the pipe. In some embodiments of the present invention, the plurality of outer gland segments are two outer gland segments. The rear walls of the two outer gland segments, when connected, define an inside diameter that is larger than an outside diameter of the pipe, and define a circumference that is substantially equal to a circumference of the pipe.

According to other embodiments of the present invention, a pipe connecting apparatus is provided for coupling pipe ends, wherein an end of a first pipe is inserted into a bell housing on an end of a second pipe, and wherein the bell housing has a radially outwardly extending flange. The apparatus includes an outer gland assembly comprising a plurality of outer gland segments adapted to engage the first and second pipes, a sealing member, and an inner gland assembly. Each outer gland segment has an arcuate wall with a groove formed therein, a rear wall extending radially inward from the arcuate wall, an intermediate wall extending radially inward from the arcuate wall between the rear wall and the groove. Each outer gland segment also includes a pair of connection members for adjustably connecting one outer gland segment to one or more other outer gland segments via fasteners. When connected, the outer gland segments define an annular groove and adjacent first and second annular spaces. The annular groove is configured to receive an outer edge of the bell end flange. The sealing member is disposed within the first annular space and is adapted to surround the first pipe, abut against the bell end flange, and provide a seal between the first and second pipes. The inner gland assembly is disposed within the second annular space and is adapted to surround the first pipe. The inner gland assembly includes a plurality of pipe gripping members, each pipe gripping member having at least one tooth. Each pipe gripping member is pivotable within the annular space in response to an axial force on the first and second pipes and such that the pipe gripping member teeth are inserted into a surface of the first pipe.

In some embodiments of the present invention, the rear walls of the outer gland segments, when connected, define an inside diameter that is larger than an outside diameter of the first pipe, and define a circumference that is substantially equal to a circumference of the first pipe. In some embodiments of the present invention, the plurality of outer gland segments are two outer gland segments. The rear walls of the two outer gland segments, when connected, define an inside diameter that is larger than an outside diameter of the first pipe, and define a circumference that is substantially equal to a circumference of the first pipe.

The bell end flange outer edge includes a plurality of notches, and the outer gland segments are positioned such that a notch is located between respective connection members of adjacent outer gland segments. A plurality of spacers are provided for engagement with the respective plurality of notches. In some embodiments of the present invention, each spacer has an elongated key member that is configured to extend between the respective connection members and to removably engage a respective notch. In some embodiments of the present invention, the elongated key member of each spacer includes a free end portion having a tapered configuration.

In some embodiments of the present invention each connection member of an outer gland segment includes a groove. Each spacer includes a pair of opposing ribs extending outwardly from the elongated key member that are configured to slidably engage grooves in respective connection members of adjacent outer gland segments.

In some embodiments of the present invention, each spacer includes an elongated side arm oriented transverse to the elongated key member. The elongated side aim facilitates removable engagement of a respective spacer with a notch in the bell end flange.

The above and other features of the invention, including various novel details of construction and combination of parts, will now be more particularly described with reference to the accompanying drawings. It will be understood that the particular device embodying the invention is shown by way of illustration only and not as a limitation of the invention. The principles and features of this invention may be employed in various and numerous embodiments without departing from the scope of the invention.

### BRIEF DESCRIPTION OF THE DRAWINGS

The accompanying drawings, which form a part of the specification, illustrate various embodiments of the present invention. The drawings and description together serve to fully explain embodiments of the present invention.

FIG. 1A is a perspective view of a pipe connecting apparatus, according to some embodiments of the present invention.

FIG. 1B is a perspective view of a pipe connecting apparatus, according to some embodiments of the present invention.

FIG. 2 is an end view of the pipe connecting apparatus of FIGS. 1A and 1B with the compound glands in a closed position.

FIG. 3 is an end view of the pipe connecting apparatus of FIGS. 1A and 1B with the compound glands in an open position.

FIG. 4 is a cross sectional view of the pipe connecting apparatus of FIG. 3 taken along line A-A.

FIG. 5 is an exploded perspective view of the pipe connecting apparatus of FIGS. 1A and 1B.

FIG. 6 is a perspective view of a pipe fitting bell according to some embodiments of the present invention.

FIG. 7A is a perspective view of an inner gland half according to some embodiments of the present invention.

FIG. 7B is an end view of the inner gland half of FIG. 7A.

FIG. 8A is a perspective view of a cam-like wedge according to some embodiments of the present invention.

FIG. 8B is a perspective view of a cam-like wedge according to other embodiments of the present invention.

FIG. 9A is a perspective view of an outer gland half according to some embodiments of the present invention.

FIG. 9B is a perspective view of an outer gland half according to some embodiments of the present invention.

FIG. 10 is a partial sectional view of the outer gland half of FIG. 9A.

FIG. 11A is a perspective view of a spacer according to some embodiments of the present invention.

FIG. 11B is a perspective view of a spacer according to some embodiments of the present invention.

### DETAILED DESCRIPTION

The present invention now is described more fully hereinafter with reference to the accompanying drawings, in which some embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element, or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if an illustrated embodiment in the figures is inverted, elements described as “under” or “beneath” other elements or features would then be oriented “over” the other elements or features. Thus, the exemplary term “under” can encompass both an orientation of “over” and “under”. The embodiment may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

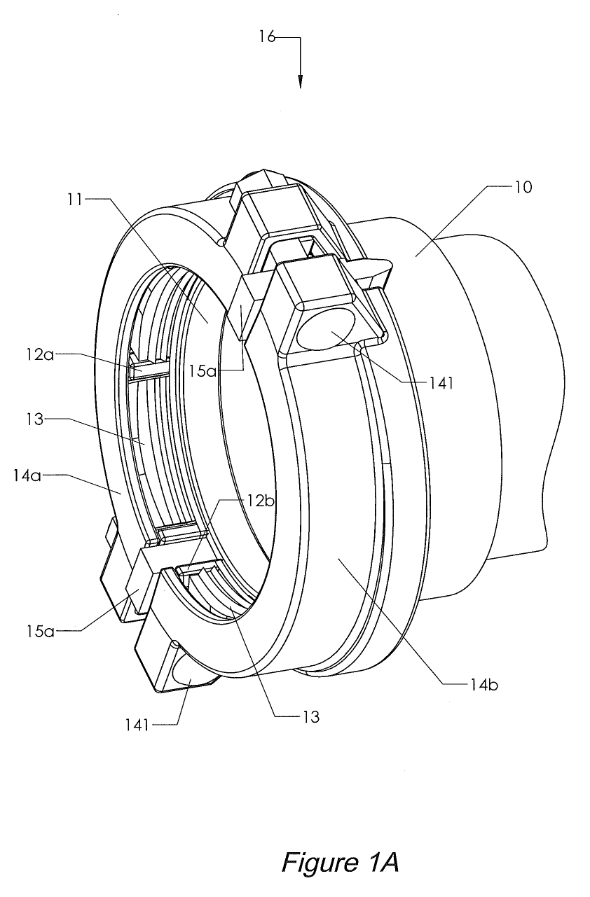

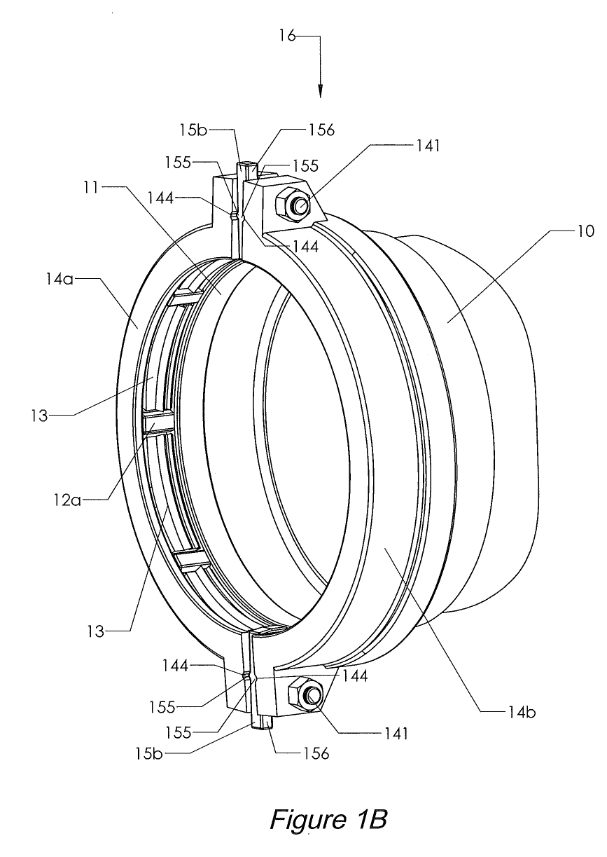

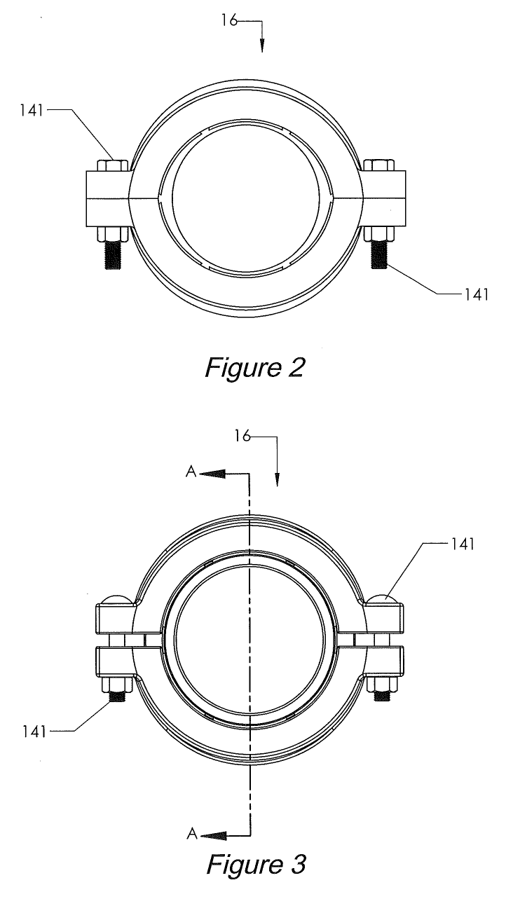

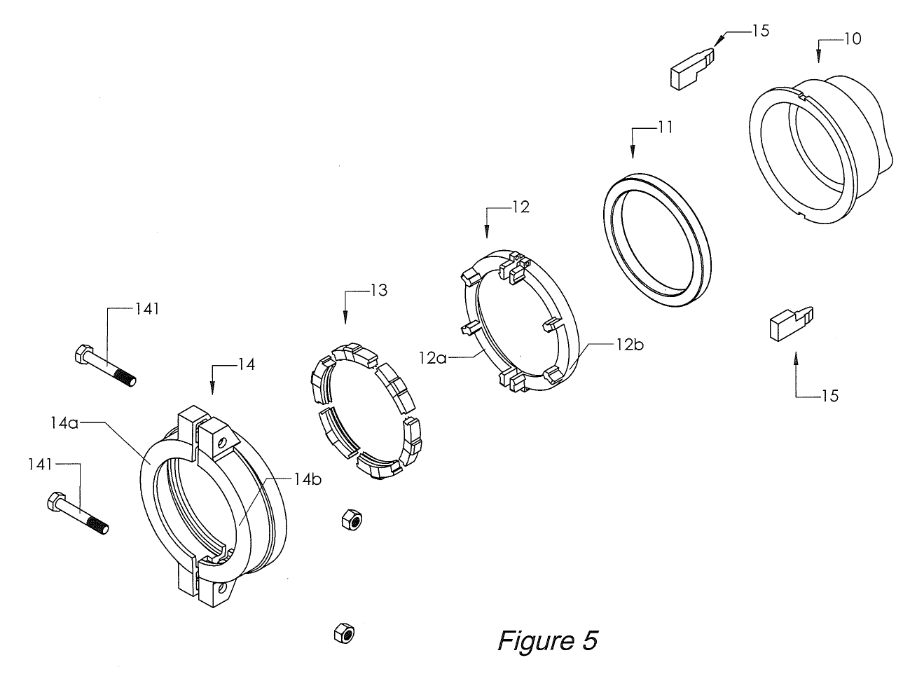

FIGS. 1A-1B, 2, 3, 4 and 5 illustrate a pipe connecting apparatus 16, also referred to as a compound gland or gland assembly, according to some embodiments of the present invention. The pipe connecting apparatus 16 contains a bell 10 (i.e., the bell end of a pipe), a sealing ring (gasket) 11, inner gland assembly 12 (comprising gland segments 12a, 12b), cam-like wedges (pipe gripping members) 13, outer gland assembly 14 (comprising gland segments 14a, 14b), and spacers 15 (FIG. 5), 15a (FIG. 1A), 15b (FIG. 1B).

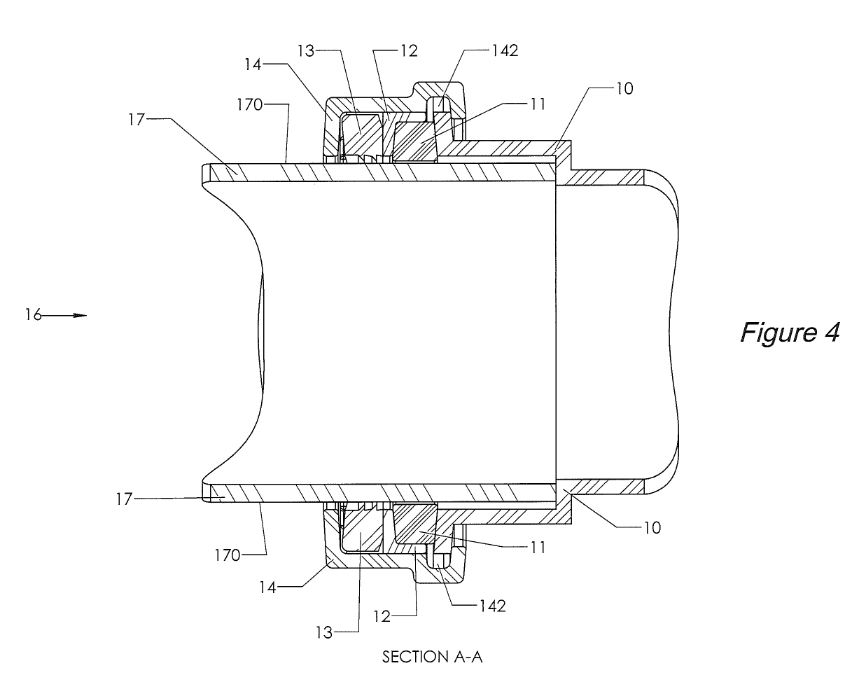

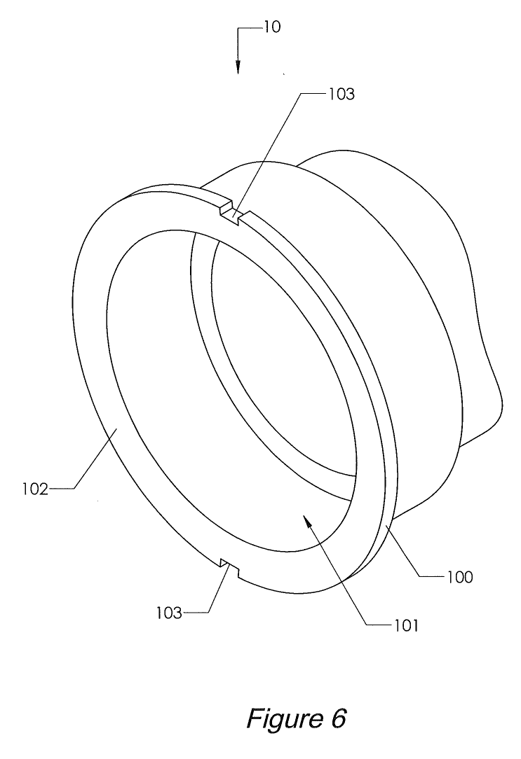

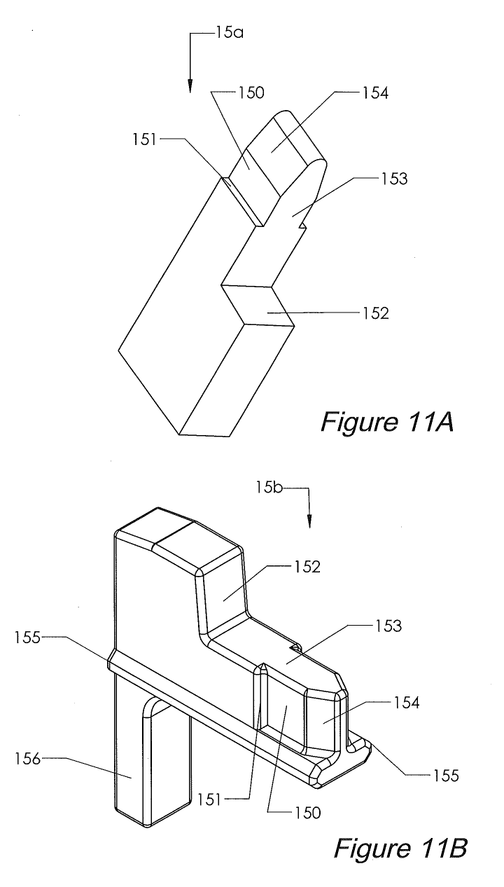

Referring to FIG. 6 and FIGS. 11A-11B, the pipe or fitting bell 10 is composed of an expanded annular space 101 adapted to receive a pipe end 17 (FIG. 4). Surrounding the annular space 101 is a flange-like rim 100 creating a sealing surface on the approximately radial plane of the face 102 of the bell. Formed in the flange-like rim are at least two notches 103 performing the function of keyways adapted to receive the centering key portion 150 of a spacer 15.

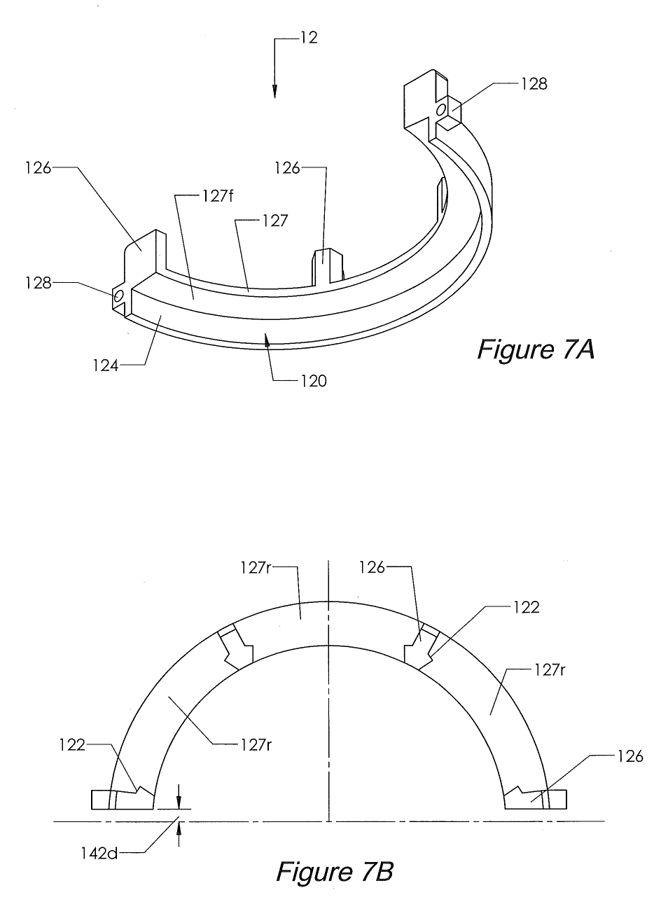

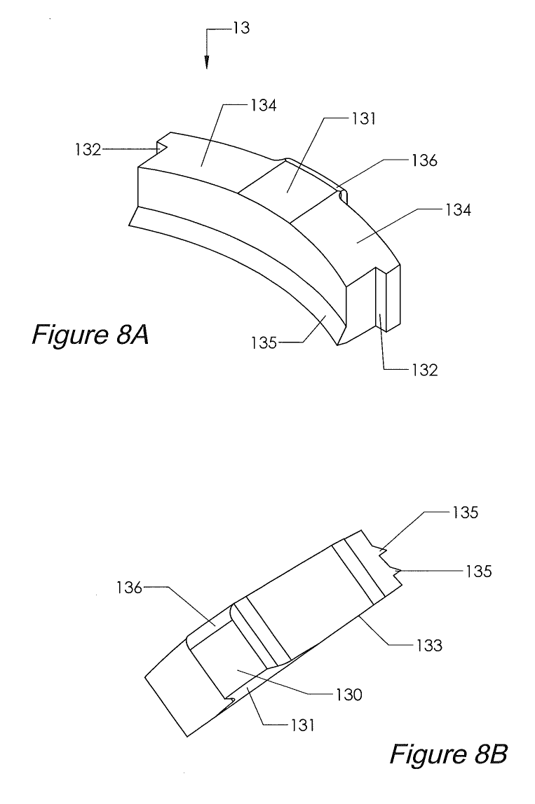

Referring to FIGS. 7A-7B and FIGS. 8A-8B, the inner gland assembly 12 is composed of two halves or segments 12a, 12b, each having a front side containing an annular space 120 consisting of a top circumferential wall 124 and an approximately radial rear wall 127 having a front surface 127f shaped to conform to the shape of a contained sealing ring 11 (FIG. 1). The radial wall 127 has a rear surface 127r from which extend multiple supports 126 for supporting, containing, guiding, and limiting the rotation of multiple wedges 13 (FIGS. 8A-8B). The wedges 13 are laid on surface 127r between supports 126 having wedge surfaces 132 contacting support surfaces 122 oriented such that wedge front surface 133 touches inner gland surface 127r. Tabs 128 extend beyond each inner gland half 12a, 12b (FIG. 7A) and are adapted to be inserted into a recess 149 in a respective outer gland half 14a, 14b and attached to the respective outer gland half 14a, 14b with screws, bolts or other fastening devices.

Referring to FIGS. 8A-8B, FIG. 9 and FIG. 10, each cam-like wedge 13 has a pivot point (i.e., an arcuate edge portion) 136 located at the rear of the wedge 13 and, in some embodiments, contacts the junction of the circumferential surface 146 and rear wall 147 of the outer gland assembly 14. Pivot point 136 is the radial load bearing area of the wedge 13 during and after rotation. Surface 130 contacts the circumferential surface 146 and is the radial load bearing surface during tightening of the side bolts 141. Flat surface 130 serves to prevent premature rotation of the wedge 13. Surface 131 is the axial load bearing area of the wedge and defines a plane at an acute angle with the rear wall of the outer gland 147, allowing for a rotation of, for example, 5 to 10 degrees. In action, the outer gland halves 14a, 14b are brought together by tightening bolts 141 to approximately 75-90 ft.lbs. During tightening, radial load bearing surface 130 keeps the cam-like wedge 13 rigid and straight, taking the load required to slightly insert the at least one tooth 135 into the pipe surface 170 insuring that an axial load and not a radial load causes the wedge 13 to rotate.

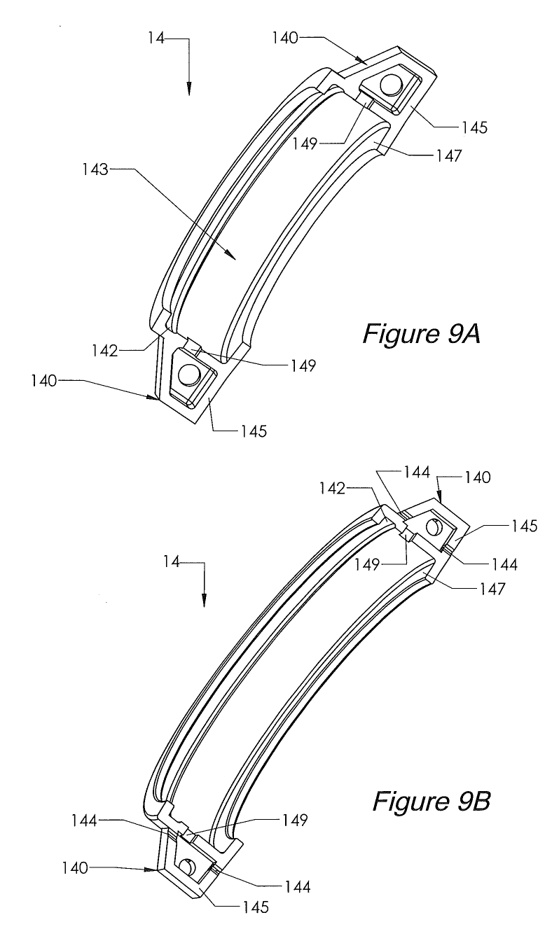

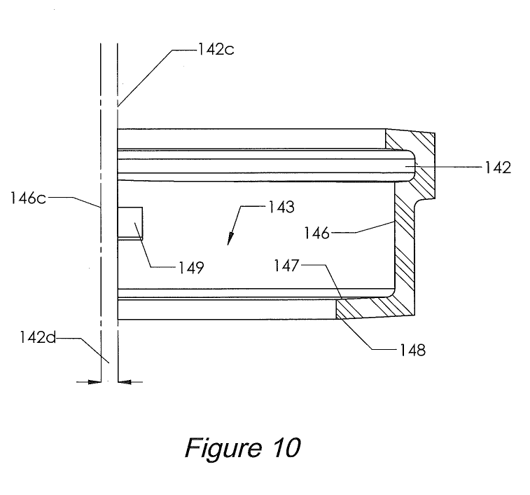

Referring to FIG. 6, FIG. 9 and FIG. 10, the outer gland assembly 14 is composed of at least two segments 14a, 14b (also referred to herein in the illustrated embodiment as outer gland halves), each segment 14a, 14b containing side extensions (connection members) 140 for connecting bolts 141. Each segment 14a, 14b consists of a first circumferential annular groove 142, and a second circumferential annular space 143. The first circumferential groove 142 is adapted to fit around, be guided by, and close upon the flange-like outer rim 100 of the bell 10. The first circumferential groove 142 has a radius slightly larger than the radius of the rim 100 with a center 142c aligned with the face of the two side extensions 145 so that when bolts 141 are tightened the first groove 142 closes to near completion surrounding flange-like rim 100. The second annular space 143 consists of a circumferentially extending surface 146 and a radially extending rear wall 147 combining to form an annular space 143 to contain the inner gland assembly 12, multiple cam-like wedges 13 and sealing ring 11. The radius of the circumferentially extending surface 146 and the radius of rear wall surface 148 have the same center 146c located in line with center 142c and separated by a distance 142d calculated using the maximum and minimum circumference of the outside surface of an inserted pipe 17 (FIG. 4). In the case of DIPS and IPS pipe, the radius of the rear wall surface 148 is larger than the radius of the DIPS pipe and the center is offset by an amount calculated using the minimum circumference of the IPS pipe. As the at least two outer gland segments 14a, 14b are closed by tightening bolts 141, rear wall surface 148 pushes and deflects the outside diameter of the inserted pipe 17 so that the pipe takes an oval shape and fills the space, created by the closing surface 148. Recessed space 149 is adapted to receive inner gland half tab 128.

As axial force is applied by hydraulic pressure, external force, and/or thermal contraction, the pipe surface 170 moves to withdraw from the expanded annular space 101. As the withdrawing axial movement takes place, each wedge 13 rotates about pivot point 136 inserting the at least one tooth 135 into pipe surface 170. Rotation continues until load bearing surface 131 contacts the rear wall 147 of the outer gland and wedge surfaces 132 contact inner gland surfaces 122. As rotation takes place, each wedge 13 is guided into position by the supports 126 of the inner gland 12. Surfaces 134 define planes at a slightly oblique angle to load bearing surface 131 preventing contact with the rear wall of the outer gland 147. This prevents the outer edges of the surface 134 from contacting the rear wall 147 prior to surface 131 and thus eliminates large beam loads on the wedges 13.

Referring to FIG. 1, FIG. 4 and FIGS. 11A-11B, the pipe connecting apparatus 16, consisting of outer gland halves 14a, 14b, inner gland halves 12a, 12b, cam-like wedges 13, sealing ring 11 and bolts 141, is held in an open position and centered in alignment with the axial centerline of the expanded bell space 101 by at least two spacers 15 inserted between gland halves 14a, 14b contacting surfaces 145 and held in place by bolts 141. Centering is accomplished by inserting the key portion 150 into keyway-like notch 103. Insertion is limited by contact of spacer surfaces 151 with flange-like rim surface 102. The sealing ring 11 is further protected during shipment by the spacer surfaces 152 and 153 adapted to conform to the exposed shape of the gasket. The spacers 15 are removed after insertion of pipe end 17. Tapered section 154 of the spacer 15 extends axially beyond side extension 140 and is used to start the removal of the spacer 15 from between the gland halves 14a, 14b. The tapered section 154 prevents the sudden off-setting of the pipe connecting apparatus 16 which can occur as the spacers 15 are removed.

Referring to FIGS. 1B, 9B and 11B, a spacer 15b, according to other embodiments of the present invention is illustrated. The illustrated spacer 15b has additional guide/retention ribs 155 and an insertion/removal side arm 156. The spacer 15b is inserted between the compound gland halves 14a and 14b and contacting grooves 144 and key way like slot 103. The combined grooves 144 and ribs 155 serve to guide the spacer into position and prevent the spacer from being dislodged from keyway 103 during shipment and handling. Side arm 156 serves as an insertion and removal aide rendering it unnecessary to insert fingers between the compound gland halves. The side arm does not extend beyond surface 14a (FIG. 1B) and therefore allows surface 14a to contact a pallet completely during shipment.

It is to be understood that the present invention is by no means limited to the particular construction herein disclosed and/or shown on the drawings, but also comprises any modifications or equivalents within the scope of the claims. For example the sealing ring 11 may be contained in a separate annular space within the outer gland 14 and the inner gland 12 comprising a separate and independent support system for the cam-like wedges 13.

That which is claimed:

1. A pipe connecting apparatus for coupling pipe ends, wherein an end of a first pipe is inserted into a bell housing on an end of a second pipe, and wherein the bell housing has a radially outwardly extending flange, the apparatus comprising:
an outer gland assembly comprising a plurality of outer gland segments adapted to engage the first and second pipes, wherein each outer gland segment comprises an arcuate wall with a groove formed therein, a rear wall extending radially inward from the arcuate wall, and a pair of connection members for adjustably connecting one outer gland segment to one or more other outer gland segments via fasteners, wherein the outer gland segments, when connected, define an annular groove and an adjacent annular space, wherein the annular groove is configured to receive an outer edge of the bell end flange;
a sealing member disposed within the annular space, the sealing member adapted to surround the first pipe, abut against the bell end flange, and provide a seal between the first and second pipes; and
an inner gland assembly disposed within the annular space adjacent the sealing member and adapted to surround the first pipe, wherein the inner gland assembly comprises a plurality of pipe gripping members, wherein each pipe gripping member comprises at least one tooth, and wherein each pipe gripping member is pivotable within the annular space in response to an axial force on the first and second pipes and such that each pipe gripping member at least one tooth is inserted into a surface of the first pipe.

2. The pipe connecting apparatus of claim 1, wherein each pipe gripping member has an arcuate pipe engaging face with opposite front and rear edges and at least one elongated, arcuate tooth extending outwardly from the pipe engaging face between the front and rear edges.

3. The pipe connecting apparatus of claim 1, wherein the inner gland assembly comprises a plurality of inner gland segments, each inner gland segment secured to a respective outer gland segment, wherein each inner gland segment comprises opposite front and rear sides, wherein the front side of each inner gland segment abuts the sealing member, and wherein the rear side of each inner gland segment comprises a plurality of circumferentially spaced-apart supports extending outwardly therefrom that are adapted to support one or more pipe gripping members.

4. The pipe connecting apparatus of claim 1, wherein the bell end flange outer edge comprises a plurality of notches, and wherein the outer gland segments are positioned such that a notch is located between respective connection members of adjacent outer gland segments, and further comprising a plurality of spacers, each having an elongated key member configured to extend between the respective connection members and to removably engage a respective notch.

5. The pipe connecting apparatus of claim 4, wherein the elongated key member of each spacer comprises a free end portion having a tapered configuration.

6. The pipe connecting apparatus of claim 4, wherein each spacer comprises an elongated side arm oriented transverse to the elongated key member, wherein the elongated side arm facilitates removable engagement of a respective spacer with a notch.

7. The pipe connecting apparatus of claim 4, wherein each connection member comprises a groove, and wherein each spacer comprises a pair of opposing ribs extending outwardly from the elongated key member, wherein the ribs are configured to slidably engage grooves in respective connection members of adjacent outer gland segments.

8. The pipe connecting apparatus of claim 1, wherein each gripping member comprises a planar rear face opposite the pipe engaging face and a planar axial load bearing surface extending between the rear face and pipe engaging face, wherein the axial load bearing surface defines a plane having an angle relative to a plane defined by the rear face of less than ninety degrees (90°).

9. The pipe connecting apparatus of claim 8, wherein the axial load bearing surface defines a plane having an angle relative to a plane defined by the rear face of between about seventy five degrees and about eighty five degrees (75°-85°).

10. The pipe connecting apparatus of claim 3, wherein each gripping member comprises opposite end portions and wherein each end portion is configured to engage and be supported by a respective support.

11. The pipe connecting apparatus of claim 8, wherein the rear face of each of the pipe gripping members comprises an arcuate edge portion that facilitates pivotal movement of the pipe gripping members within the annular space.

12. The pipe connecting apparatus of claim 1, wherein each gripping member is pivotable within the annular space between about five degrees and about fifteen degrees (5°-15°).

13. The pipe connecting apparatus of claim 1, wherein each pipe gripping member tooth comprises front and rear walls converging to form a gripping edge, and wherein a portion of the pipe engaging face between the front edge thereof and the tooth front wall forms an angle with the tooth front wall of less than ninety degrees (90°).

14. The pipe connecting apparatus of claim 2, wherein the at least one elongated, arcuate tooth comprises a plurality of elongated, arcuate teeth.

15. The pipe connecting apparatus of claim 3, wherein each outer gland segment arcuate wall comprises at least one notch formed therein, and wherein each inner gland segment comprises at least one alignment tab configured to be received within the at least one notch to align the inner gland segment with the outer gland segment.

16. The pipe connecting apparatus of claim 1, wherein the sealing member is attached to the outer gland assembly within the annular space.

17. The pipe connecting apparatus of claim 3, wherein the inner gland segments and gripping members comprise polymeric material.

18. The pipe connecting apparatus of claim 3, wherein the outer gland segments comprise iron, steel, or aluminum.

19. The pipe connecting apparatus of claim 1, wherein the rear walls of the outer gland segments, when connected, define an inside diameter that is larger than an outside diameter of the first pipe, and define a circumference that is substantially equal to a circumference of the first pipe.

20. The pipe connecting apparatus of claim 1, wherein the plurality of outer gland segments comprise two outer gland segments, and wherein the rear walls of the two outer gland segments, when connected, define an inside diameter that is larger than an outside diameter of the first pipe, and define a circumference that is substantially equal to a circumference of the first pipe.

21. A pipe connecting apparatus, comprising:
a bell housing having opposite first and second ends, wherein the first end is adapted to receive a pipe end therethrough and includes a radially outwardly extending flange, wherein an outer edge of the flange comprises a plurality of notches;
an outer gland assembly comprising a plurality of outer gland segments, wherein each outer gland segment comprises an arcuate wall with a groove formed therein, a rear wall extending radially inward from the arcuate wall, and a pair of connection members for adjustably connecting one outer gland segment to one or more other outer gland segments via fasteners, wherein the outer gland segments, when connected, define an annular groove and an adjacent annular space, wherein the annular groove receives the outer edge of the bell end flange, wherein the outer gland segments are positioned such that a notch is located between respective connection members of adjacent outer gland segments;
a sealing member disposed within the annular space, the sealing member adapted to surround a pipe inserted within the bell housing first end and abut against the bell end flange;
an inner gland assembly disposed within the annular space adjacent the sealing member and adapted to surround a pipe inserted within the bell housing first end, wherein the inner gland assembly comprises a plurality of pipe gripping members, wherein each pipe gripping member comprises at least one tooth, and wherein each pipe gripping member is pivotable within the annular space in response to an axial force on the pipe and such that each pipe gripping member at least one tooth is inserted into a surface of the pipe; and
a plurality of spacers, each spacer having an elongated key member configured to extend between respective connection members of adjacent outer gland segments and to removably engage a respective notch.

22. The pipe connecting apparatus of claim 21, wherein the rear walls of the outer gland segments, when connected, define an inside diameter that is larger than an outside diameter of the pipe, and define a circumference that is substantially equal to a circumference of the pipe.

23. The pipe connecting apparatus of claim 21, wherein the plurality of outer gland segments comprise two outer gland segments, and wherein the rear walls of the two outer gland segments, when connected, define an inside diameter that is larger than an outside diameter of the pipe, and define a circumference that is substantially equal to a circumference of the pipe.

24. A pipe connecting apparatus for coupling pipe ends, wherein an end of a first pipe is inserted into a bell housing on an end of a second pipe, and wherein the bell housing has a radially outwardly extending flange, the apparatus comprising:
an outer gland assembly comprising a plurality of outer gland segments adapted to engage the first and second pipes, wherein each outer gland segment comprises an arcuate wall with a groove formed therein, a rear wall extending radially inward from the arcuate wall, an intermediate wall extending radially inward from the arcuate wall between the rear wall and the groove, and a pair of connection members for adjustably connecting one outer gland segment to one or more other outer gland segments via fasteners, wherein the outer gland segments, when connected, define an annular groove and adjacent first and second annular spaces, wherein the annular groove is configured to receive an outer edge of the bell end flange;
a sealing member disposed within the first annular space, the sealing member adapted to surround the first pipe, abut against the bell end flange, and provide a seal between the first and second pipes; and
an inner gland assembly disposed within the second annular space and adapted to surround the first pipe, wherein the inner gland assembly comprises a plurality of pipe gripping members, wherein each pipe gripping member comprises at least one tooth, and wherein each pipe gripping member is pivotable within the annular space in response to an axial force on the first and second pipes and such that each pipe gripping member at least one tooth is inserted into a surface of the first pipe.

25. The pipe connecting apparatus of claim 24, wherein the rear walls of the outer gland segments, when connected, define an inside diameter that is larger than an outside diameter of the first pipe, and define a circumference that is substantially equal to a circumference of the first pipe.

26. The pipe connecting apparatus of claim 24, wherein the plurality of outer gland segments comprise two outer gland segments, and wherein the rear walls of the two outer gland segments, when connected, define an inside diameter that is larger than an outside diameter of the first pipe, and define a circumference that is substantially equal to a circumference of the first pipe.

27. The pipe connecting apparatus of claim 24, wherein the bell housing flange outer edge comprises a plurality of notches, and wherein the outer gland segments are positioned such that a notch is located between respective connection members of adjacent outer gland segments, and further comprising a plurality of spacers, each having an elongated key member configured to extend between the respective connection members and to removably engage a respective notch.

28. The pipe connecting apparatus of claim 27, wherein the elongated key member of each spacer comprises a free end portion having a tapered configuration.

29. The pipe connecting apparatus of claim 27, wherein each spacer comprises an elongated side arm oriented transverse to the elongated key member, wherein the elongated side arm facilitates removable engagement of a respective spacer with a notch.

30. The pipe connecting apparatus of claim 27, wherein each connection member comprises a groove, and wherein each spacer comprises a pair of opposing ribs extending outwardly from the elongated key member, wherein the ribs are configured to slidably engage grooves in respective connection members of adjacent outer gland segments.
